(19) United States
(12) Patent Application Publication
(10) Pub. No.: US 2012/0085541 A1
(43) Pub. Date: Apr. 12, 2012

(54) Method and Apparatus for Hydraulically Fracturing Wells

(75) Inventors: Douglas N. Love, Granbury, TX (US); Thomas G. Hill, JR., Conroe, TX (US)

(73) Assignee: QIP HOLDINGS, LLC, The Woodlands, TX (US)

(21) Appl. No.: 13/271,802

(22) Filed: Oct. 12, 2011

Related U.S. Application Data
(60) Provisional application No. 61/392,376, filed on Oct. 12, 2010.

(51) Int. Cl. E21B 43/26; G06Q 30/02

(52) U.S. Cl. 166/308.1; 166/177.5; 705/26.4

(57) ABSTRACT

A mobile plant for supplying hydraulic fracturing service to a well is provided. The plant is particularly useful for wells that require multi-stage fracturing treatments, where the surface equipment may not be moved for longer times than when supplying conventional treatments. Skid-mounted equipment is used, so that the transport vehicle for the equipment can be released after delivery of the equipment to a well site. A method for marketing and executing fracturing treatments is also provided, wherein a customer is provided price data for each item included in the total cost of a fracturing treatment, along with software for calculating the total cost of a treatment to be purchased. The customer may calculate the cost of a treatment from computer-readable storage or over the internet. The customer may also monitor the fracturing treatment remotely and obtain a post-treatment report.

This application claims priority to provisional application Ser. No. 61/392,376 filed on Oct. 12, 2010

### BACKGROUND OF INVENTION

1. Field of the Invention

This invention relates to the hydraulic fracturing of oil and gas wells. In particular, skid-mounted equipment to form a “Mobile Frac Plant” is provided, along with an improved method for marketing and executing hydraulic fracturing operations.

2. Description of Related Art

Hydraulic fracturing of wells became commercial in the U.S. in 1949, using a single truck and small volumes of hydraulic fracturing fluid. The process has been continuously improved, with increasing amounts of fluid and increasing horsepower to pump the fluids into a well. A new era in hydraulic fracturing began in recent years, when it was found that wells can be drilled horizontally for large distances through shale zones and hydraulically fractured at multiple locations along the horizontal section of the well. This new capability for producing “shale gas” has opened vast natural gas resources to economic development, changing the world energy outlook to an extent unimagined a few years ago. A recent survey of shale gas fracturing is provided in the paper SPE 133456, “Thirty Years of Gas Shale Fracturing: What Have We Learned?,” Society of Petroleum :Engineers, 2010. Still, hydraulic fracturing in vertical wells continues to make possible recovery of hydrocarbons from wells that could not be economically drilled without a following fracturing treatment. Over 70 per cent of wells drilled today in the U.S. are hydraulically fractured soon after drilling.

In recent years, fracturing of shale from horizontal wells to produce gas has become a major part of the hydraulic fracturing market. To perform a fracturing treatment of a horizontal well, it is common for 15,000 to 30,000 hydraulic horsepower, supplied by pumps mounted on a fleet of trucks, to be moved to the well site. The quantities of fluid and proppant to be pumped and the flow properties of the fluid needed for a particular well are determined by the frac design.

In vertical wells, apparatus for hydraulic fracturing is commonly used for one day at a well then moved to another well. When hydraulically fracturing horizontal wells, multiple stages of fracturing occur in a single well. There are reports of as many as 30 to 40 fracturing treatments in a single horizontal well. There may be multiple wells per location. Therefore, hydraulic fracturing equipment at the surface may remain at the same location for a number of days or weeks.

The combination of various equipment used for hydraulic fracturing of a well is known in the industry as a “spread,” The “frac spread” includes truck-mounted pumps, a blender used for mixing chemicals and proppant into the fracturing fluid, a manifold and flow lines connecting the pumps to a well head. The industry business model for a pumping service company has been to fracture one or a few stages in a well and demobilize the trucks and equipment for a move to another well. Mobile equipment for short-term utilization that can be quickly demobilized was of paramount importance. Fleets of thousands of pump trucks with these capabilities have been created, each having a tractor and trailer or a truck-mounted pump for connection to a mixing system. The present pumping service industry is, to a large degree, made up of trucking companies that also pump water and sand. But the operations of a pumping service company change dramatically when fracturing horizontal wells. Typically, twelve to twenty trucks move onto a well site at one time and stay for days, often weeks. When the job is completed, this fleet of trucks typically moves directly to another well site and also stays there for weeks, rarely going to their home yard. Each truck requires at least one DOT driver, who normally stays with his truck, idling the engine continuously for days, occasionally increasing RPMs when a frac is actively being done in effect, the driver must operate on the highways, moving the equipment on and off location, and operate the complex equipment. Often on a frac job as many as fifty people are required at any given time due to all the tractors and pressure pumping equipment being utilized. There are too many people on location. Most have little to do most of the time but sit in their truck. Trucks notwithstanding, the actual number of people required is less than half. A well site is a dangerous place, and having 25-30 non-essential personnel on location, round the clock poses both safety issues and adds a very high operating expense to the operation. There is a need to have only personnel that are necessary on the well site.

The most dangerous activity the pumping service does today is moving such heavy equipment over the highways. This is done with drivers, while DOT certified, whose primary job is to operate High Pressure/High Temperature (HPHT) pumps and other equipment. Often drivers asked to move equipment after working an “operational shift” are fatigued as they leave the well site. This can present safety issues on the highway. In fact, the most dangerous activity includes driving on public highways. There is a need to establish a system where professional equipment movers move the equipment, and leave the frac'ing to those who know that business best.

There are also too many trucks on location. This requires a large footprint to accommodate so much heavy equipment and a large amount of fuel to keep the many trucks idling for weeks. The trucks cause continuous noise pollution and diesel exhaust emissions. The noise and smell of exhaust may be apparent for up to a mile, or even further, from such locations. Also, pumping service companies have too much capital tied up in tractors for frac spreads intended for high mobility that move only every week or two.

Oil and gas producers operate on small margins when drilling “unconventional plays' in North America. Pumping service companies providing hydraulic fracturing have a need to work on a highly efficient business model to enable the robust drilling programs that are necessary in today's industry. A new, more nearly optimized hydraulic fracturing paradigm is necessary. The industry has an over-abundance of one to five stages per day frac capacity. The market needs a “fit-for purpose” apparatus and method that is optimized for shale gas development programs in North America and around the world.

There is a need for an improved and optimized fracing system that can bring a spread to a well site having the same pumping capability as prior art spreads but that reduces capital and operational costs, decreases the number of people on location, over-the-road risks, footprint of the spread, air pollution, noise, and energy consumption and increases well site safety.

A variety of patents describe equipment innovations for decreasing costs of fracturing treatments. U.S. Pat. No. 7,051,818 discloses a combined power unit for a nitrogen injection system by coil tubing. A prime mover engine coupled to coil tubing and fluid units is mounted on a single trailer or skid, which can be dropped off at a jobsite—a tractor is not required to remain with the trailer Or skid, U.S. Pat. No. 4,724,907 discloses equipment for mixing surfactants and water and an oil solvent for injection into a well. The equipment may be mounted on a skid. U.S. Pat. App. Pub. No. 2009/0301725 discloses apparatus to prevent flow of proppant through the high-pressure pumps, so as to decrease wear of the pumps.

The procedures used for marketing and organizing hydraulic fracturing services in the industry have not changed significantly for many years. FIG. 1 illustrates how the functions are normally allocated. A well operator decides that a hydraulic fracturing treatment of its well may be economically attractive. The operator gathers data for the well and the properties of the reservoir around the well. Those data may be supplied to engineers employed by the operator, to consulting engineers or to a “pumping service company” (as shown in FIG. 1) to “design” a Treatment.” In either case, a design of a fracturing treatment of the well is developed, using software and a computer. The design specifies the amount of fluid to be pumped, rate and pressure of pumping and amount of proppant and other chemicals to be added to the fluid pumped. For each combination, the design calculation includes a predicted rate of production of the well after the treatment. Several computer programs are widely used in industry and are available for purchase or license from companies that do not supply pumping services. The operator compares cost estimates for the alternative designs and selects a treatment. A pumping service company then assembles the equipment necessary for executing the designed treatment. The service company owns and operates the high-pressure pumps needed and usually purchases proppant, polymers to be added to the water and other chemicals from material suppliers. The service company then pumps the treatment according to design or to modifications found to be necessary during pumping of the treatment.

Service companies compete to sell services and products to well operators based. primarily on price and service. Price books are published by pumping service companies, listing pumping costs, chemicals, proppants, transportation and other costs separately, but deep “discounts” are made from the price books for the total treatment cost. An operator may set an objective for a well treatment and obtain bids from two or more service companies for a total price of a treatment. Because price books are not followed, there is very limited transparency to the cost of each component of the treatment, so that the operator cannot arrive at the optimum. treatment for his circumstances. Also, an operator may benefit by purchasing components of the fracturing treatment—such as proppant, polymer and chemicals—from third-party suppliers. But, this decision is not possible when the cost of each component that is actually being charged an operator is not known to the operator or customer. There is a need for a method for marketing and executing fracturing treatments that makes the process of purchasing a treatment transparent to a customer and allows the customer to select an optimum treatment for his well based on computer-readable data and interactive cost calculations.

### BRIEF SUMMARY OF THE INVENTION

A Mobile Fracturing Plant is provided. Equipment is mounted on skids and is delivered to a well site and unloaded. Pumps may be powered conventionally or by electrical power produced at the well site by natural gas. A method of using the mobile equipment is provided. A method for preparing a bid or cost estimate for treating a well by hydraulic fracturing is provided, using price information and calculations of total cost in a computer system. Price of each item making up the cost of a treatment is provided to a customer in terms of cost per unit of consumption and the customer can use a computer system to obtain the total cost of a treatment. Third-party purchases may be included in the calculations.

### BRIEF DESCRIPTION OF THE SEVERAL VIEWS OF THE DRAWING(S)

FIG. 1 is a sketch of procedures now used by well operators, pumping service companies and material suppliers for hydraulic fracturing operations in industry.

FIG. 2 is a plan view of a prior art fracturing spread.

FIG. 3 is a plan view of a fracturing spread as disclosed herein.

FIG. 4 shows an elevation view of a skid-mounted pump (a), electrical generator (b) and blender (c).

FIG. 5 shows a sketch of procedures for designing a fracturing treatment for a well and making an agreement between a well operator and a service company for hydraulic fracturing operations as disclosed herein.

FIG. 6 is a sketch of procedures after an agreement between a vendor (pumping service company) and customer (well operator) has been made.

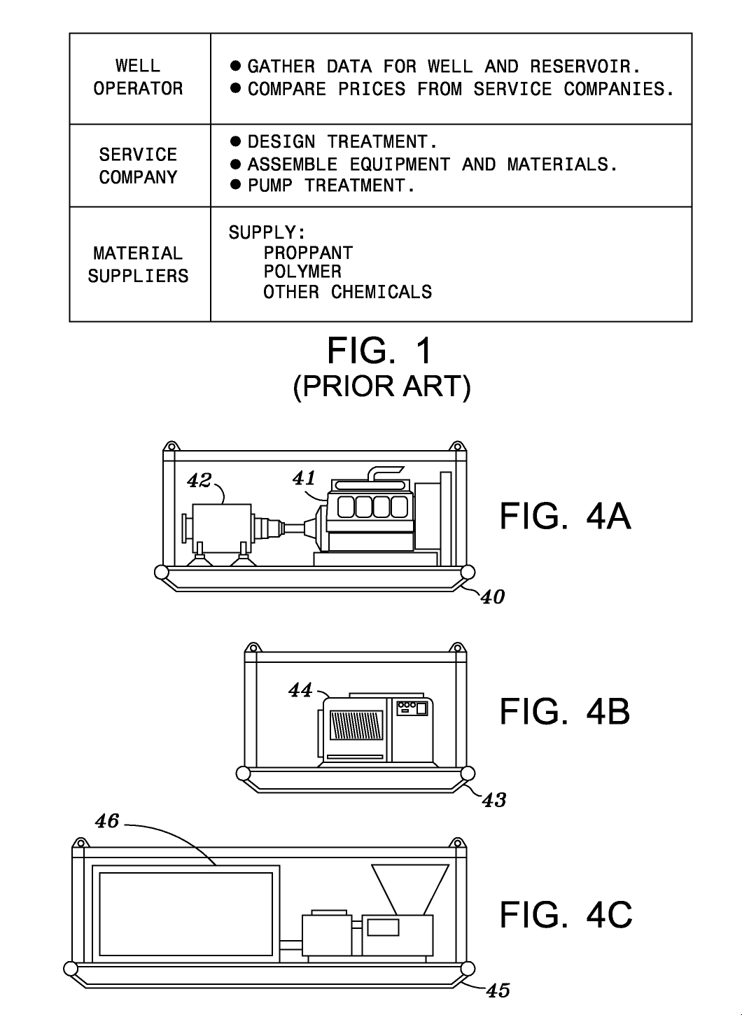

### DETAILED DESCRIPTION OF THE INVENTION

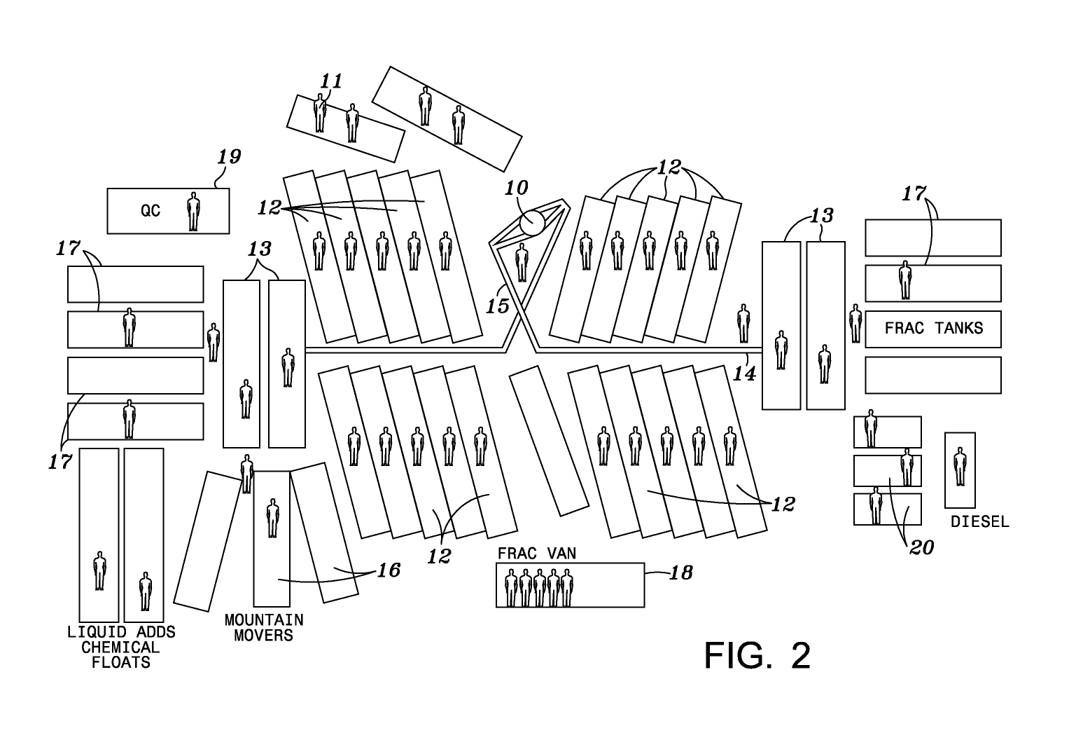

FIG. 2 is a diagram of a hydraulic fracturing spread used to hydraulically fracture well 10 using conventional methods. The formation of each fracture (each “stage”) requires injection of hundreds of thousands of gallons of fluid under high pressure supplied by pumps 12, which are normally mounted on trucks. The trucks remain at the well site throughout treatment of well 10. Manifold 14 connects pumps 12 to flow line 15, which is connected to well 10. Fluid and additives are blended in blender 13 and taken by manifold to the intake or suction of pumps 12. Proppant storage vessels 16 and liquid storage vessels 17 may be used for maintaining a supply of materials during a treatment. Wells are often fractured by 10-20 stages of fracturing treatment. The total amount of fluid pumped under high pressure is often in the range of 3-5 million gallons. Quality control tests of the fluid and additives may be performed in structure 19 before and during well treatments. Fuel for prime movers of the pumps may be stored in tanks 20.

Persons normally present at a well site and their locations are indicated by symbols, such as symbol 11. It is not uncommon for about 50 persons employed by the pumping service company to be present at the well site. These persons are indicated by the symbols at different locations and associated with different equipment in the frac spread. Including support crews, there may be as many as 70 people around the well.

The blended fluids under high pressure (often as high as 10-45,000 psig) and proppant are pumped into the well, fracturing the surrounding formation. The proppant “props” and holds the fractured formation open to enhance rate of gas or oil recovery. The fluid is normally water. A polymer such as polyacrylamide is usually added to the water to decrease friction loss as the water is pumped down a well. (Water containing the polymer is usually called “slick water,”) Other polymers may be used during a treatment to form a more viscous fluid. Proppant is added to the fluid to prevent closure of fractures after pumping stops. Other chemicals, such as biocides, corrosion inhibitors, clay stabilizers and other chemicals may be added in small concentrations. Proppants, polymers and other chemicals are supplied by well-known suppliers in industry. In conventional treatments, these materials are purchased by the service company.

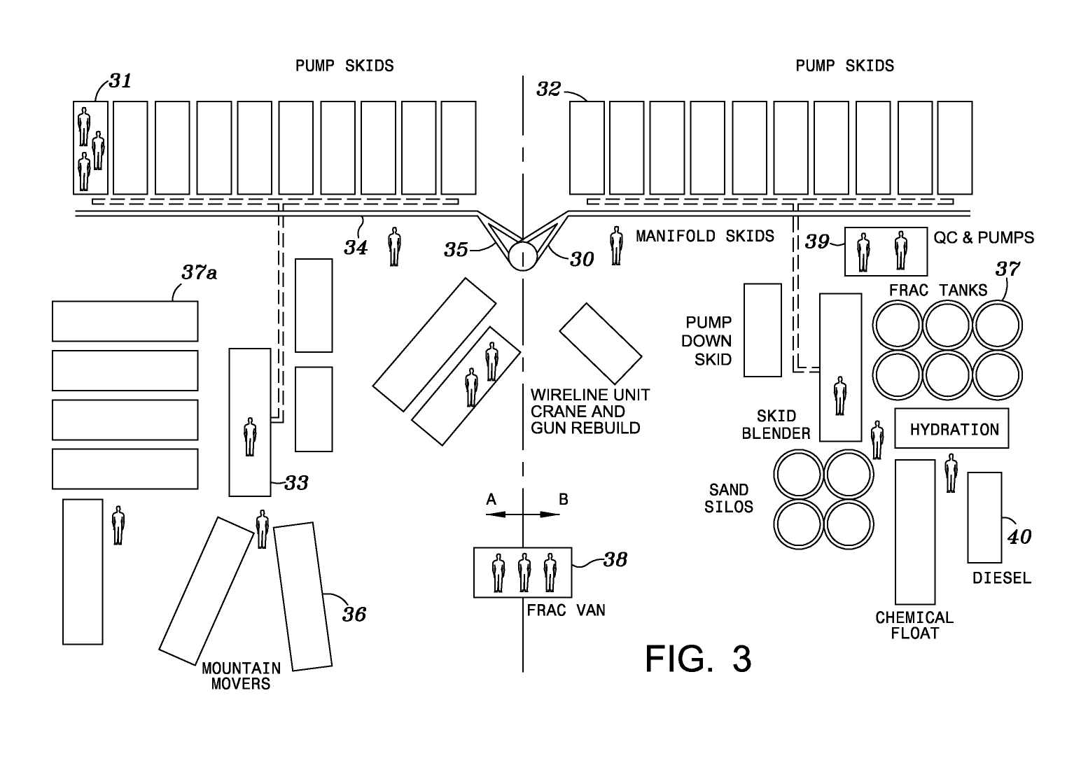

FIG. 3 is a representation of the frac spread of the present invention for fracturing well 30, utilizing space-saving pump skids 32, skid-mounted blender 33, fluid tanks 37, manifold lines 34, control or instrument van 38 and proppant storage vessel 36. Necessary personnel 31 are represented by symbols and are shown at their approximate duty station. In this configuration, 18 people are needed to operate the frac spread per 12-hour shift, for a total of 36 on a 24 hour basis. Shown in this figure are two separate concepts, mirrored about the dashed centerline. Concept B utilizes vertical frac tanks 37(b). Concept A utilizes traditional horizontal frac tanks 37(a).

The present invention (see FIG. 3) is essentially a “Mobile Frac Plant” or “frac spread” utilizing fit-for-purpose skid-mounted equipment, rather than traditional mobile pump trucks. Where the traditional frac spread is a collection of trucks, the present invention is optimized for unconventional tight gas plays—designed to stay on location for longer periods of time for multi-stage fracturing operations than traditional truck-mounted frac spreads.

The Mobile Frac Plant is tailored to be moved onto location quickly by flatbed trucks, is mobilized and demobilized quickly, eliminates unnecessary personnel on location, and totally eliminates diesel tractors sitting at idle for weeks at a time. This results in a reduction of both capital expense costs for equipment purchase and operational costs in personnel and fuel. Other advantages are reduced noise, reduced carbon dioxide and carbon monoxide emissions, and a marked reduction of the footprint requirement on the fracturing pad. Also, personnel safety is greatly enhanced as fewer people are exposed to the dangerous environment of the well site. Professional moving companies may be employed to mobilize and demobilize the Mobile Frac Plant, thereby effectively managing the risk of moving the equipment over the highways.

FIG. 4(a) illustrates skid-mounted pumps for use in the Mobile Frac Plant of FIG. 3. Skid 40, adapted for moving individually, has mounted thereon prime mover 41 and high-pressure pump 42, which may be a conventional diesel-powered frac pump. More than one pump of prime mover may be mounted on a single skid. Alternatively, prime mover 41 may be an electric motor. Electric power for electric motor 41 may be supplied by electrical generator 44 mounted on sled 43, as shown in FIG. 4(b). Generator 44 may be powered by a turbine or motor fueled by natural gas available at a well site. The use of natural gas to generate power may drastically reduce usage of diesel fuel during fracturing operations, thereby reducing operating expenses for the fracturing treatment. FIG. 4(c) illustrates skid-mounted blender 46, on sled 45. Blender 46 may be a conventional blender used for mixing fracturing fluids and adding proppant. A second blender (not shown) may be used to aid in hydration of polymers in the fracturing fluid.

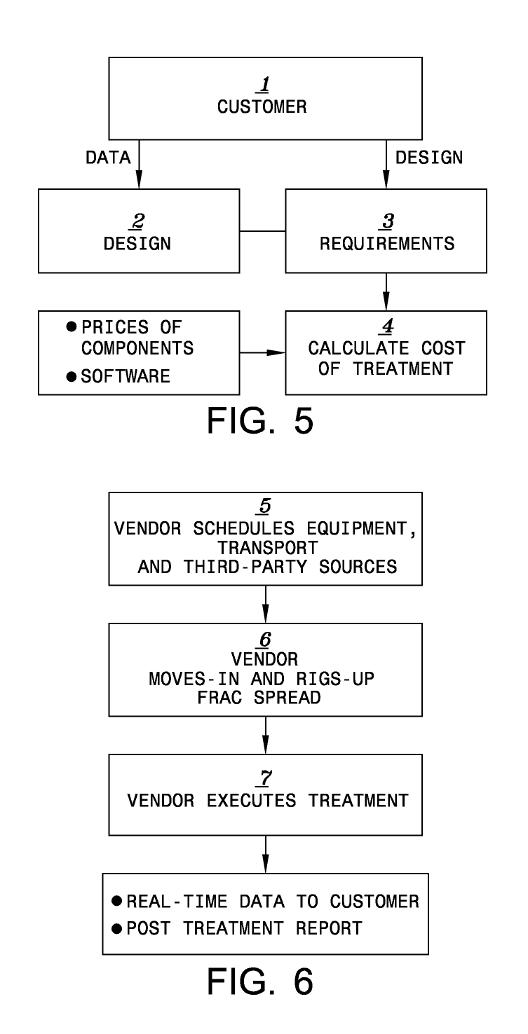

FIG. 5 illustrates procedures of a Vendor (service company) for hydraulic fracturing services in industry according to methods disclosed herein. In Block 1, a Customer (well operator) provides data, preferably through an internet-based data interactive program or by stored medium supplied by Vendor (service company). Preferably, Vendor provides an input form to be used by Customer. The data may be a frac design that Customer has already selected or it may be well and reservoir data that Vendor may use to prepare or have prepared a frac design (Block 2). The frac design prescribes requirements for materials and pumping equipment for a treatment (Block 3). This information is used in Vendors price data base for components (horsepower and materials) and computer system to calculate costs of the design treatment (Block 4). Alternate designs may be considered and total costs calculated for each. Results are then sent to Customer. Costs are shown for each component that contributes to total cost. Customer selects the treatment to be pumped and may designate alternate treatments in case well conditions are not as expected during the treatment. Thus, Customer is “in the loop” for selecting total cost of the treatment, considering all cost components.

FIG. 6 illustrates procedures used by Vendor after an agreement with Customer has been made. Vendor uses information from the fracture design to schedule pumping and other equipment and arrange to have it transported to the well site. Normally, the transport step will be similar to that taken to move a drilling rig or other equipment that is moved to well sites. Vendor may also arrange for delivery of materials from third-party sources (Block 5). Vendor will then move in and rig up the equipment used in the frac spread or Mobile Frac Plant (Block 6). Vendor then executes the treatment (Block 7). During the treatment, Vendor may provide real-time data to Customer. After the treatment, Vendor preferably supplies a report providing details of the treatment and an accounting for each item or component making up the total cost of the treatment.

Although the present invention has been described with respect to specific details, it is not intended that such details should be regarded as limitations on the scope of the invention, except to the extent that they are included in the accompanying claims. It is understood that modifications to the invention may be made as might occur to one skilled in the field of the invention within the scope of the appended claims. All embodiments contemplated hereunder that achieve the objects of the invention have not been shown in complete detail. Other embodiments may be developed without departing from the spirit of the invention or from the scope of the appended claims. Although the present invention has been described with respect to specific details, it is not intended that such details should be regarded as limitations on the scope of the invention, except to the extent that they are included in the accompanying claims.

We claim:

1. A method for treating a well drilled through a subsurface formation by hydraulic fracturing, comprising:
moving a plurality of pumps on skids, a blender on a skid and a manifold to a well site, unloading the pump, blender and manifold and connecting the blender, pump, and a flow line to the well through the manifold;
mixing a component in a fluid in the blender and pumping the fluid through the manifold and flow line into the well at a pressure high enough to fracture the subsurface formation.

2. The method of claim 1 wherein the manifold is on a skid.

3. The method of claim 1 further comprising moving a storage vessel for the fluid and a storage vessel for the component to the well site.

4. The method of claim 1 further comprising moving an instrument van on a skid to the well site and connecting an instrument in the van to a pump, blender or manifold.

5. A Mobile Frac Plant for hydraulic fracturing of a subterranean formation, comprising:
a plurality of pumps mounted on skids, a blender mounted on a skid, a manifold connecting the blender and the pumps, and a manifold connecting the pumps and a flow line; and
a plurality of vessels and equipment for storing and transferring a fluid and a proppant to the blender.

6. The Mobile Frac Plant of claim 5 further comprising an instrument van on a skid, the van having an instrument connected to a pump, blender or manifold.

7. A method for preparing a bid for treating a well by hydraulic fracturing, comprising:
(a) placing information providing a price per unit of consumption of a plurality of products and services required for performing a hydraulic fracturing treatment of a well in computer-readable form in a data base;
(b) providing a method in computer-readable form for calculating the total cost of a hydraulic fracturing treatment designed for the well, based on the information of step (a); and
(c) providing the information of step (a) and the method of step (b) to a customer or potential customer.

8. The method of claim 7 wherein the price of at least one of the products is supplied by a third party.

9. The method of claim 7 wherein in step (c) the information and the method are provided to a customer or potential customer on a computer-readable medium.

10. The method of claim 7 wherein in step (c) the information and the method are provided on the internet.

11. The method of claim 10 wherein the information and the method are provided on the internet only to users having a password.
